(19) United States
(12) Patent Application Publication
(10) Pub. No.: US 2026/0367901 A1
(43) Pub. Date: Nov. 19, 2026

(54) MANAGING UPDATE VERSIONS TO LAYERS IN AN IMAGE

(71) Applicant: INTERNATIONAL BUSINESS MACHINES CORPORATION, ARMONK, NY (US)

(72) Inventors: Yu Zui You, Ningbo (CN); Xiao Ling Chen, Changping District (CN); Xinpeng Liu, Austin, TX (US); Hao Sheng, Ningbo (CN)

(21) Appl. No.: 19/210,642

(22) Filed: May 16, 2025

(51) Int. Cl. G06F 8/65

(52) U.S. Cl. CPC G06F 8/65

(57) ABSTRACT

Aspects of the present disclosure relate to managing update versions to layers in an image. Updates to layers of an image can be received. Transaction records for the updates to the layers can be maintained, wherein the transaction records for the updates to the layers are represented in a hierarchical relationship. A parent transaction record and a child transaction record indicated in a parent-child relationship in the hierarchical relationship can be provided, wherein the parent transaction record indicates a first update to a layer and the child transaction record indicates a second update to the layer received after the first update; A cryptographic hash of the input, in the child transaction record, can be included, the input comprising content in the second update to the layer and a parent hash in the parent transaction record. The hierarchical relationship can be used to manage the updates to the layers.

### BACKGROUND OF THE INVENTION

The present invention relates to a computer implemented method, system, and computer program product for managing update versions to layers in an image.

Enterprises may adopt privatized deployment environments to meet security and compliance requirements. Enterprises may deploy container images comprising an executable package of software including all programs needed to run a piece of software, such as code, runtime, libraries, dependencies, and configuration files. Images are built from a series of layers, each representing a set of changes (e.g., adding files or installing dependencies). Layers are cached and reused for efficiency. Layers are compressed and stored as blobs (binary large objects) in a distributed storage system, typically on a cloud infrastructure.

Images and their layers may be stored in a repository for deployment to users. Docker Hub® stores container images in a cloud-based registry using a combination of storage, metadata management, and distribution mechanisms. (Docker Hub is a registered trademark of Docker, Inc. throughout the world).

### SUMMARY

Aspects of the present disclosure relate to computer program products, systems, and methods for managing update versions to layers in an image. Updates to layers of an image can be received. Transaction records for the updates to the layers can be maintained, wherein the transaction records for the updates to the layers are represented in a hierarchical relationship. A parent transaction record and a child transaction record indicated in a parent-child relationship in the hierarchical relationship can be provided, wherein the parent transaction record indicates a first update to a layer and the child transaction record indicates a second update to the layer received after the first update; A cryptographic hash of the input, in the child transaction record, can be included, the input comprising content in the second update to the layer and a parent hash in the parent transaction record. The hierarchical relationship can be used to manage the updates to the layers.

### BRIEF DESCRIPTION OF THE DRAWINGS

FIG. 1 illustrates an embodiment of a system for managing updates to layers of an image.

FIG. 2 illustrates an embodiment of a transaction record for an update to a layer of the image.

FIG. 3 illustrates an embodiment of layer metadata providing status information on a layer.

FIG. 4 illustrates an embodiment of a compatibility rule for an update version for a layer indicating allowed and blocked dependencies for updates in other layers.

FIG. 5 illustrates an embodiment of a hierarchical relationship of transaction records.

FIG. 6 illustrates an embodiment of operations process an update to a layer of the image.

FIG. 7 illustrates an embodiment of operations to process a request to delete a layer in an image.

FIG. 8 illustrates an embodiment of operations to provide a storage path for the update to the layer.

FIG. 9 illustrates an embodiment of operations to freeze a layer.

FIG. 10 illustrates an embodiment of operations to rollback an update for a layer to a lower rollback update at a lower version from the current version running on the layer.

FIG. 11 illustrates a computing environment in which the components of FIG. 1 may be implemented.

### DETAILED DESCRIPTION

Some of the challenges faced in managing images and their layers is managing revisions to layers. A large number of historical versions need to be maintained to support different environments (development, testing, and production), which occupies large storage space and makes management difficult. Traditional mirror labels (such as v1.0, v2.0) are simple and cannot effectively manage the dependency between multiple versions, especially when rolling back or patch updating is required. Further, although existing container warehouses (such as Harbor and Artifactory) support version management, they lack fine-grained version freezing, time stamp management, immutable and other functions, making it difficult to meet strict security audit requirements.

Described embodiments provide improvements to computer technology for managing container image versions utilizing a hierarchical relationship of transaction records representing version updates for the different layers of the image. Described embodiments allow for version management of numerous versions across layers and to manage compatibility and dependency of versions to ensure that any freezing or rollbacks maintain capability among the version updates running for the different layers in the image.

To provide security of the updates of the layers and to manage incompatible versions, described embodiments tie each update to a parent and child update in the hierarchical relationship by creating a hash for a version update including the hash of a parent update for a layer. The chain of linked updates for a layer allows dependencies to be traced backward to the original versions of the layers forming a trusted version tree. In further embodiments, the series of linked child and parent update versions for a layer may form a blockchain to provide for security and tracking of the updates.

With described embodiments, the change history of each image layer is recorded through the hierarchical relationship, e.g., blockchain, to achieve accurate version control and complete traceability, avoiding the problem of version loss or tampering in traditional image management. The hierarchical and independent version management mode of images avoid storage expansion and management confusion caused by overall image version upgrades, and to achieve fine-grained hierarchical change control. The described embodiments provide anti-tampering mechanisms by having a hash of a child update include the hash of the parent update to ensure the security of the image version information and to satisfy the compliance requirements of high-security industries such as finance, government, and healthcare.

With described embodiments providing a version dependency tree and compatibility rule base, the dependency compatibility can be automatically verified during version rollback to ensure the stability and availability of the system after the rollback. Further, described embodiments utilize a deduplication storage strategy to store updates to the layers to avoid duplicating the same image layer. Further, the distributed storage technology is combined to improve storage efficiency and reduce storage costs.

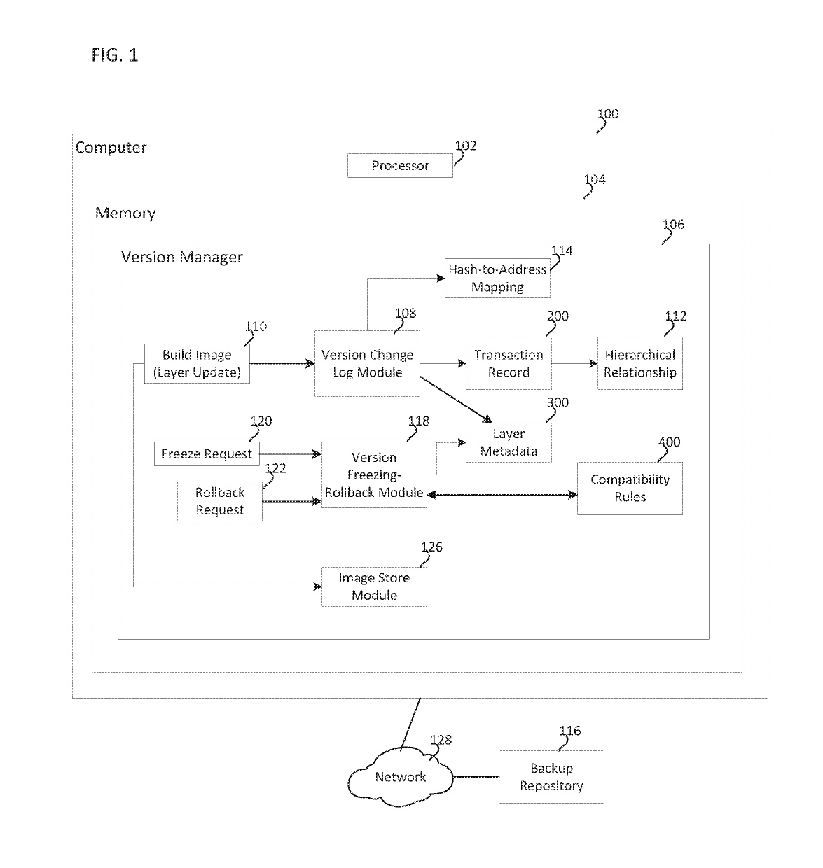

FIG. 1 illustrates a computer system 100 in which embodiments are implemented. The system 100 includes a processor 102 and a main memory 104. The main memory 104 includes a version manager 106 to manage updates to layers of an image. An image comprises a lightweight, portable, and executable package that includes everything needed to run a piece of software, such as code, runtime, libraries, dependencies, and configuration files. An image is built from a series of layers. Each layer represents a specific modification to the file system. Each of the layers may relate to a different functionality of the image. Each layer represents a change made to the file system, with each layer building on the top of the previous one.

The first layer may comprise the base or operating system layer. Middleware layers include middleware programs, such as application servers, message brokers and other software that provides services to applications. The last layers are the application layers that contain actual application code and dependencies. The same layers may be used in multiple images.

The version manager 106 includes a version change log module 108 that receives a build image 110 comprising an update to a layer. The version change log module 108 builds a transaction record 200 for the new build image 110 and updates a hierarchical relationship 112 indicating parent-child relationships of updates to layers, where each subsequent update to a layer is a child of the previous update which is the parent.

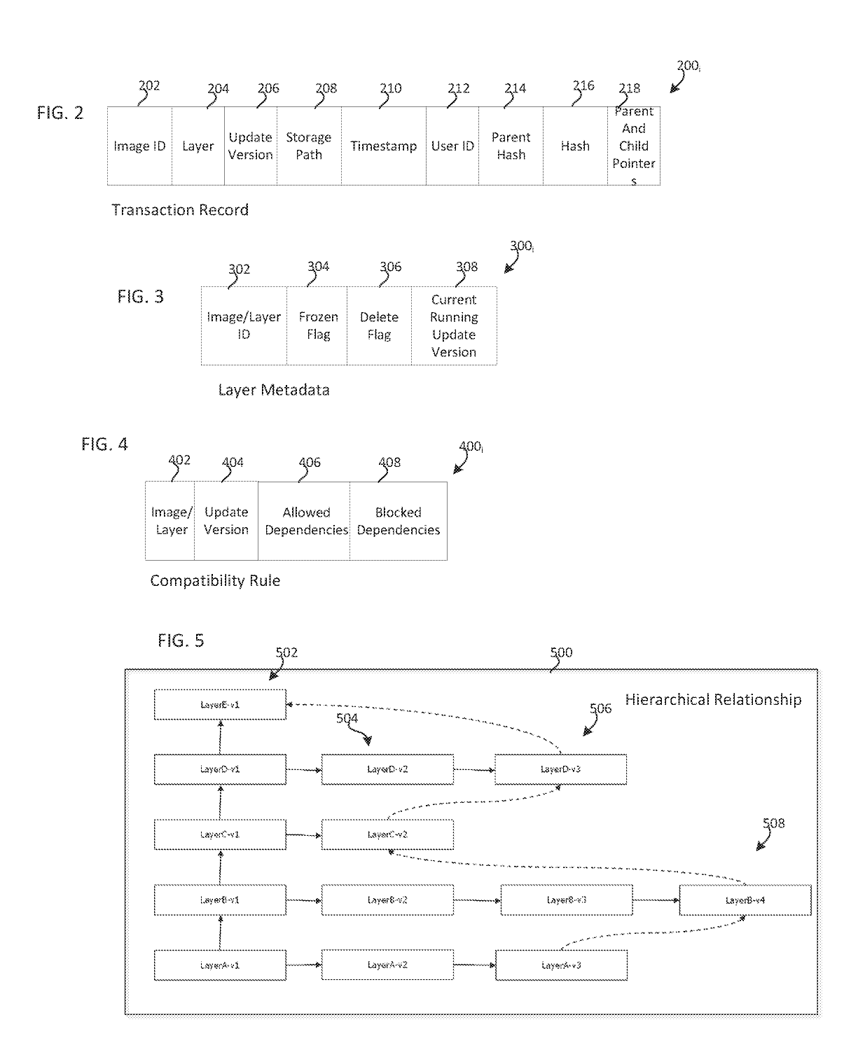

A transaction record 200ᵢ instance of the transaction records 200, as shown in FIG. 2, may include an image identifier 202 identifying the image to which the update applies, a layer 204 identifying the layer in the image to which the update applies, an update version 206, a storage path 208 where the update is stored in the repository 116, which may be encrypted, a timestamp 210 when the update was applied or update deployed, a user identifier 212 of the user of the image, a parent hash 214 comprising a hash of the parent transaction record for the update immediately preceding the current update to the layer, a hash 216 comprising a hash of input comprising any one of 202, 204, 206, 208, 210, 212, 214, etc., and parent and child pointers 218 pointing to the parent transaction record to the record 200ᵢ and the child of transaction record 200ᵢ, which would be a transaction record for a next received update. The parent and child pointers 218 form the hierarchical relationship 112. In certain embodiments, the hierarchical relationship 112 of the transaction records for a layer may comprise a blockchain of the transaction records 200. For blockchain implementations, the transaction record 200ᵢ may include a Merkel tree to allow verification of whether the transaction records have been changed since created.

A hash-to-address mapping 114 may comprise a mapping of encrypted storage paths in a backup repository 116 to the cleartext of the storage path in the backup repository 116.

A version freezing-rollback module 118 receives freeze requests 120 to freeze a layer at the current update version so no new update versions are allowed for that layer. The version freezing-rollback module 118 may further receive rollback requests 122 to rollback the update at a layer to an earlier update version to the layer. The version freezing-rollback module 118 may update layer metadata 300 to indicate whether a layer is frozen and the current update version running for that layer.

A shown in in FIG. 3, an instance of layer metadata 300ᵢ for a layer may indicate the image and layer identifier (ID) 302, a frozen flag 304 indicating whether the layer is frozen and cannot receive further updates, a delete flag 306 indicating whether the layer has been deleted or is still present in the image, and a current running update version 308 at the layer. The layer may be running at a version lower than the most recent update that was received as a result of a rollback.

The version freezing-rollback module 118 may maintain compatibility rules 400 indicating compatibility with updates for other layers, including update versions allowed and disallowed with the update version that is the subject of the rules. FIG. 4 illustrates an embodiment of a compatibility rule 400ᵢ for a layer in an image, including the image/layer 402 and update version 404 to which the rule applies, allowed dependencies 406 of update versions in other layers compatible with the update version 404, and blocked dependencies 408 of update versions in other layers not compatible with the update version 404.

An image store module 126 may determine where to store the update in the backup repository 116 and perform deduplication when storing a received update to a layer for an image. The image store module 126 may communicate with the backup repository 116 over a network 128.

The memory 104 may comprise suitable volatile or non-volatile memory devices known in the art. For instance, the memory 104 may comprise one or more memory devices volatile or non-volatile, such as a Dynamic Random Access Memory (DRAM), a phase change memory (PCM), Magnetoresistive random-access memory (MRAM), Spin Transfer Torque (STT)-MRAM, SRAM storage devices, DRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

Generally, program modules, such as the program components 106, 108, 118, 126, among others, may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 106, 108, 118, 126, among others, may be accessed by the processor 102 from the memory 104 to execute. Alternatively, some or all of the program components 106, 108, 118, 126 may be implemented in separate hardware devices, such as Application Specific Integrated Circuit (ASIC), Field Programmable Gate Arrays (FPGAs) and other hardware devices.

The functions described as performed by the program components 106, 108, 118, 126, among others, may be implemented as program code in fewer program modules than shown or implemented as program code throughout a greater number of program modules than shown.

FIG. 5 illustrates an example of a hierarchical relationship 500, such as hierarchical relationship 112. The hierarchical relationship 500 shows the dependency of layers in the first column 502 having the first version (v1) of layers A, B, C, D, E. Updates of a second version (v2) of layers A, B, C, D is applied as shown in the second column 504. Updates of a third version (v3) is applied to layers A, B, D as shown in the third column 506. An update of a fourth version (v4) is applied to layer B in the fourth column 508. The image represented by the hierarchical relationship 500 layers A, B, C, D, E are operating at their most recent update, which comprises versions v3, v4, v2, v3, and v1, respectively. The dashed arrows between the most recent updates for the layers, v3, v4, v2, v3, and v1, represent the update versions at which the layers A, B, C, D, E are operating, respectively.

The horizontal arrows across columns 502, 504, 506, 508 represent the parent-child relations between different update versions. In certain embodiments the horizontal arrows form block chains for the layers. The vertical arrows between the first version (v1) of the layers in column 502 represent a dependency relationship between layers.

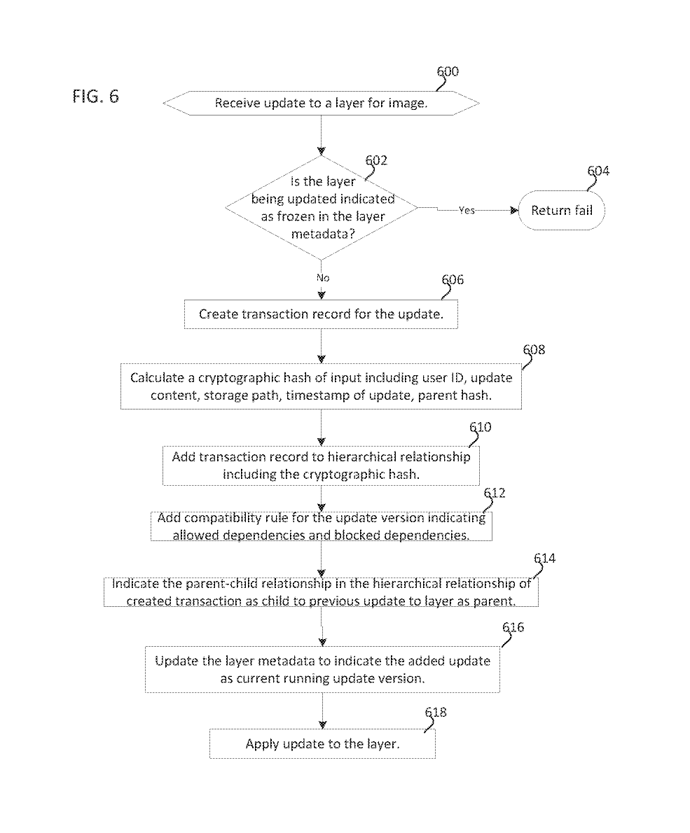

FIG. 6 illustrates an embodiment of operations performed to update a layer in an image, which in certain embodiments may be performed by the version change log module 108, or other components. Upon receiving (at block 600) an update to a layer for an image, if (at block 602) the current version of the layer being updated is indicated as frozen, such as in the frozen flag 304 in the layer metadata 300 in FIG. 3, then the update is failed (at block 604) because that layer is frozen. If (at block 602) the layer is not frozen, then a transaction record, e.g., 200ᵢ, is created (at block 606) for the received update. A cryptographic hash, e.g., SHA-256, is calculated (at block 608) from input, which may comprise a user ID, update content, storage path in which the update is stored, timestamp of the update, and the parent hash. The transaction record is added (at block 610) to the hierarchical relationship, which includes the cryptographic hash taken at block 608.

A compatibility rule, e.g., 400ᵢ, is added (at block 612) for the update version indicating allowed dependencies and blocked dependences of update versions for other layers. The parent-child relationship is indicated (at block 614) in the hierarchical relationship of the created child transaction record as a child to a previous parent transaction record indicating an update to the layer prior to the update of the child transaction record. The layer metadata for the layer, e.g., 300ᵢ, is updated (at block 616) to indicate the added update as the current running update version for the layer. The update is applied (at block 618) to the layer.

With the embodiment of FIG. 6, a transaction record for a new update to a layer includes a hash of information for the new update and the parent hash, to link the parent hash to the child hash to secure the information represented by the transaction record to avoid tampering, such as done with blockchain. Further, the chain of dependencies of the update versions can be traced backward through the chain to the original version to form a trusted version tree in the hierarchical relation.

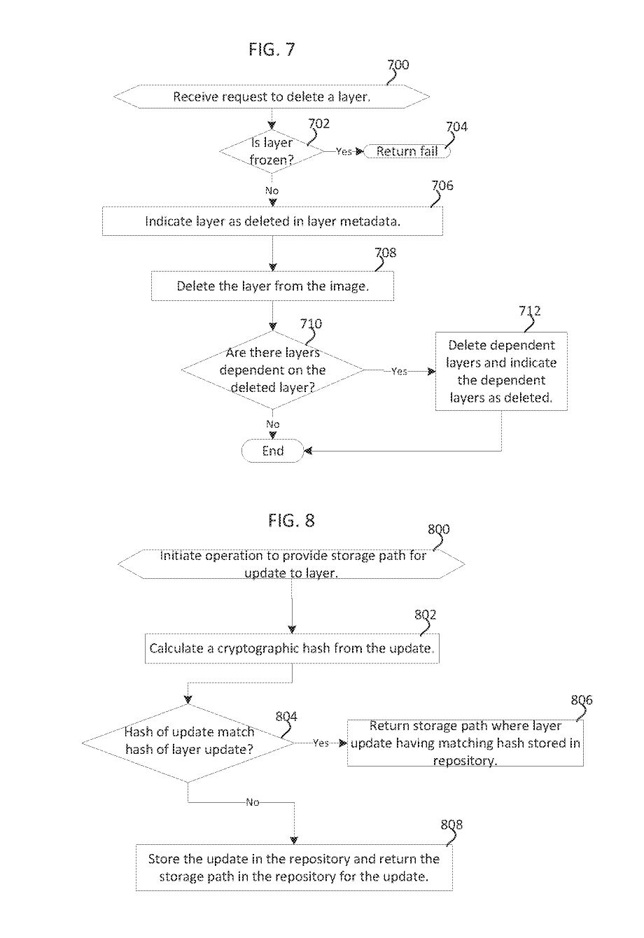

FIG. 7 illustrates an embodiment of operations performed to delete a layer in response to a request. This may be performed by the version change log module 108, or other components. Upon receiving (at block 700) a request to delete a layer, if (at block 702) the layer is frozen, such as indicated in the layer metadata, then fail is returned (at block 704) to the request. If (at block 702) the layer is not indicated as frozen, then the layer is indicated (at block 706) as deleted in layer metadata, e.g., in the delete flag 306. The indicated layer is deleted (at block 708) If (at block 710) there are other layers dependent on the deleted layer, such as layers below the deleted layer in the hierarchical relation, then the dependent layers are deleted (at block 712) and the layer metadata for the dependent layers is indicated as deleted. Otherwise, control ends if (at block 710) there are no layers dependent from the deleted layer or after indicating (at block 712) the dependent layers as deleted.

FIG. 8 illustrates an embodiment of operations performed to provide a storage path for an update to a layer. The storage path may be indicated in the transaction record for the new update. The operations of FIG. 8 may be performed by the image store module 126 or other component. Upon initiating (at block 800) an operation to provide a storage path for the update to a layer, a cryptographic hash is calculated (at block 802) from the update. A deduplication operation is performed to determine (at block 804) whether the hash matches a hash of a layer update already stored in the backup repository. If so, the storage path where the layer update having the matching hash is stored is returned (at block 806). If there is no matching hash, then the update is stored (at block 808) at a new location in the repository and the storage path where stored is returned to include in the transaction record for the update.

With the embodiment of FIG. 8, deduplication is performed to avoid storing duplicate copies of the same update at different locations in the repository. In certain embodiments, an encrypted storage path is returned and a hash-to-address mapping, e.g., 114, may maintain a mapping of encrypted storage paths to the storage path. Using an encrypted storage path and the hash-to-address mapping ensures data security and provides tamper proofing to the updates stored in the repository.

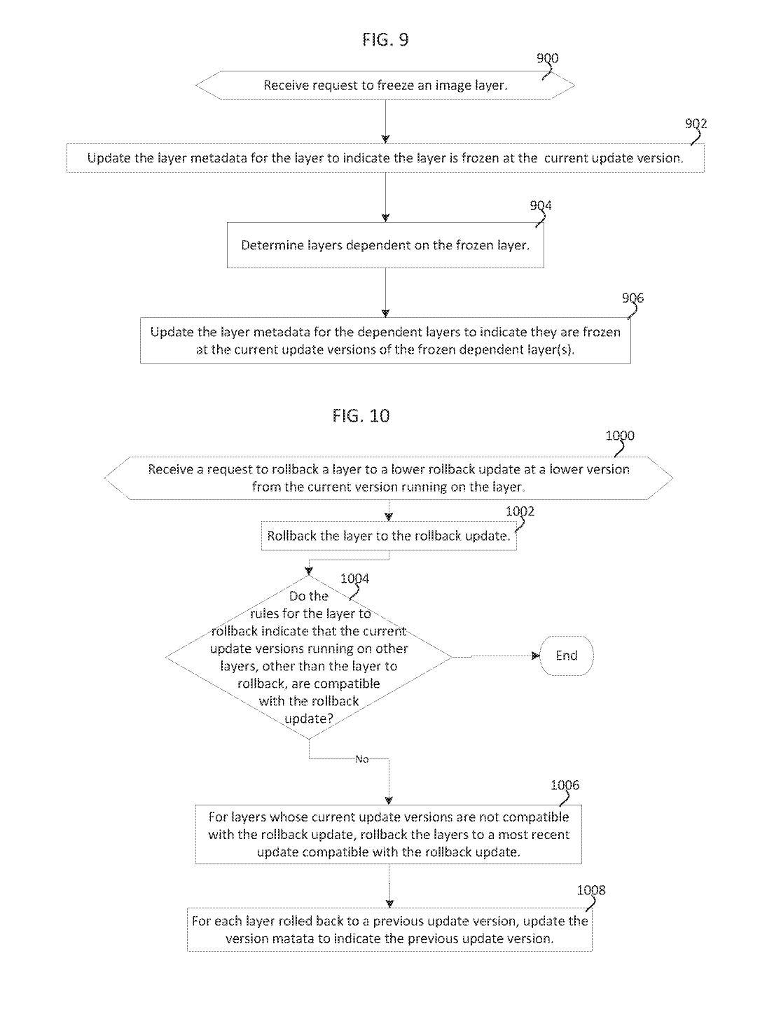

FIG. 9 illustrates an embodiment of operations to freeze updates to a layer, which may be performed by the version freezing-rollback module 118, or other component. Upon receiving (at block 900) a request to freeze an image layer, the layer metadata for the layer is updated (at block 902) to indicate the layer is frozen at the current update version. A determination is made (at block 904) of layers dependent on the frozen layer, such as layers hierarchically below the frozen layers in the hierarchical relationship. The layer metadata for the dependent layers is updated (at block 906) to indicate they are frozen at the current update versions of the frozen dependent layer(s).

With the embodiment of FIG. 9, a layer is frozen to prevent tampering or changes to the layer and prevent a layer from being modified or deleted. Further, freezing the layer ensures the historical versions cannot be modified or deleted, while allowing the upper layer in the hierarchical relation to continue with updating.

FIG. 10 illustrates an embodiment of operations to rollback an update to a layer which may be performed by the version freezing-rollback module 118, or other component. Upon receiving (at block 1000) a request to rollback a layer to a rollback update at a lower version from the current version running on the layer, the layer is rolled back (at block 1002) to the rollback update at a lower version than the current version. A determination is made (at block 1004) whether the compatibility rules for the layer to rollback indicate that the current update versions running on other layers, other than the layer to rollback, are compatible with the rollback update. If (at block 1004) there are no compatibility issues, control ends. If (at block 1004) there are update versions running on other layers not compatible with the rollback update, then, for layers whose current update versions are not compatible with the rollback update, these layers are rolled back (at block 1006) to a most recent update compatible with the rollback update. For the layers rolled back to a previous update version, update (at block 1008) the layer metadata for the layers to indicate the previous update version as the current operating version.

FIG. 10 provides a fine-grained rollback based on a trusted version tree stored in the hierarchical relationship, e.g., blockchain. Dependency compatibility is evaluated before rolling back an update to ensure that the target version is viable. An incremental rollback strategy is used to replace only the target level files and avoid the high cost of overall replacement. Further, the compatibility rules ensure that the image remains stable after a rollback to a previous update version for a layer by rolling-back the update version for other layers to be compatible with the rollback update.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment ("CPP embodiment" or "CPP") is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

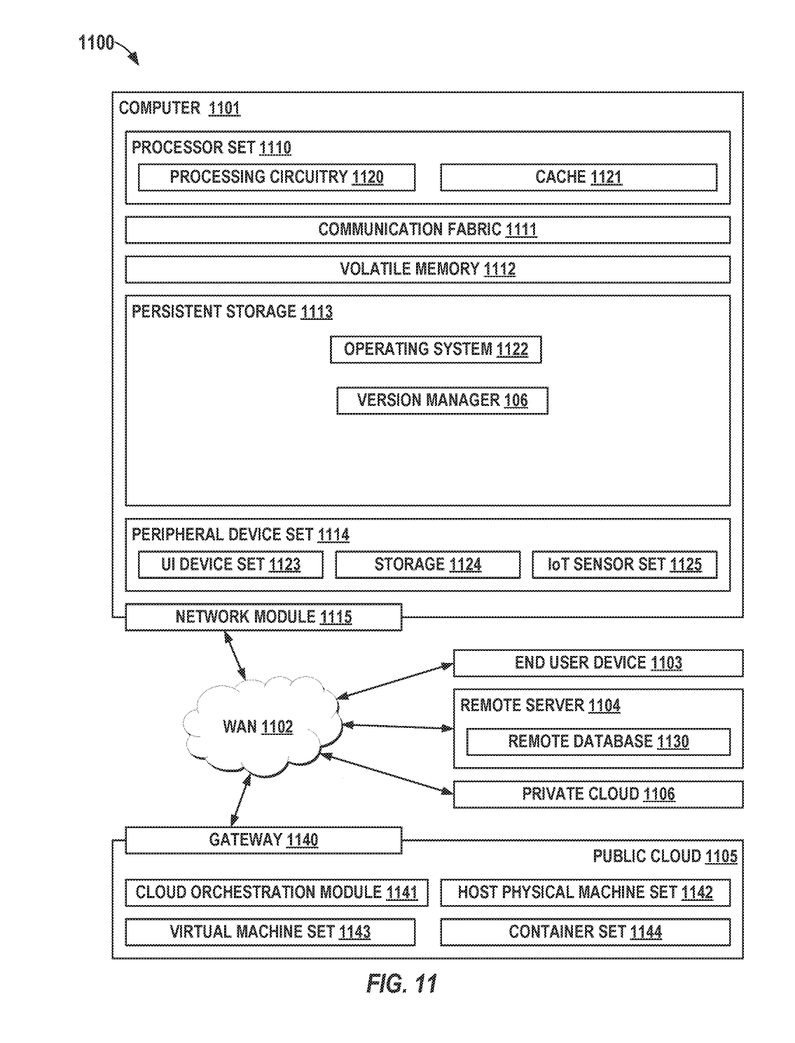

With respect to FIG. 11, computing environment 1100 contains an example of an environment for the execution of at least some of the computer code involved in performing the inventive methods, such as performed by the version manager 106, described with respect to FIG. 1, to build a hierarchical relationship of transaction records for updates to layers of an image, freeze a layer, roll back a layer, and store an update to the layer. In addition to block 106, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and version manager 106, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located "off chip." In some computing environments, processor set 1110 may be designed for working with qubits and performing quantum computing.

Computer-readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as "the inventive methods"). These computer-readable program instructions are stored in various types of computer-readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be implemented in the version manager 106 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in the version manager 106 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer-readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104. In certain embodiments, the remote server 1104 may implement the backup repository 116 of FIG. 1

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as "images." A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

CLOUD COMPUTING SERVICES AND/OR MICROSERVICES (not separately shown in FIG. 11): private and public clouds 1106 are programmed and configured to deliver cloud computing services and/or microservices (unless otherwise indicated, the word "microservices" shall be interpreted as inclusive of larger "services" regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as "as a service" technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and j, among others, are used to designate an instance of an element, i.e., a given element, or a variable number of instances of that element when used with the same or different elements.

The terms "an embodiment", "embodiment", "embodiments", "the embodiment", "the embodiments", "one or more embodiments", "some embodiments", and "one embodiment" mean "one or more (but not all) embodiments of the present invention(s)" unless expressly specified otherwise.

The terms "including", "comprising", "having" and variations thereof mean "including but not limited to", unless expressly specified otherwise.

The enumerated listing of items does not imply that any or all of the items are mutually exclusive, unless expressly specified otherwise.

The terms "a", "an" and "the" mean "one or more", unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for managing backup versions of images in a backup system, comprising:
receiving updates to layers of an image;
maintaining transaction records for the updates to the layers, wherein the transaction records for the updates to the layers are represented in a hierarchical relationship;
providing a parent transaction record and a child transaction record indicated in a parent-child relationship in the hierarchical relationship, wherein the parent transaction record indicates a first update to a layer and the child transaction record indicates a second update to the layer received after the first update;
including, in the child transaction record, a cryptographic hash of input, the input comprising content in the second update to the layer and a parent hash in the parent transaction record; and
using the hierarchical relationship to manage the updates to the layers.

2. The computer implemented method of claim 1, wherein the content in the second update comprises the second update and wherein the parent hash comprises a cryptographic hash of the parent transaction record and the first update.

3. The computer implemented method of claim 1, wherein the input to the cryptographic hash is further selected from the group consisting of a storage path in which the second update to the layer is stored in the backup system, a user identifier of a user initiating the second update to the layer, and a timestamp of the second update.

4. The computer implemented method of claim 1, further comprising:
receiving a request to freeze a layer at an update to the layer;
indicating the layer as frozen to prevent any further updates to the layer in the request to freeze; and
indicating a dependent layer dependent on the frozen layer to prevent any further updates to the dependent layer.

5. The computer implemented method of claim 4, wherein the dependent layer is indicated in the hierarchical relationship as dependent from the layer in the request to freeze, wherein updates are allowed to layers indicated in the hierarchical relationship as not dependent on the layer in the freeze request.

6. The computer implemented method of claim 1, further comprising:
receiving a request to rollback a layer to a rollback update;
determining versions of updates running on other layers other than the layer to rollback;
determining whether the update versions running on the other layers are compatible with the rollback update; and
in response to determining that the update versions running on the other layers are not compatible with the rollback update, rolling back the update versions for the other layers not compatible with the rollback update to a most recent update compatible with the rollback update.

7. The computer implemented method of claim 1, further comprising:
receiving an update to a layer;
calculating a cryptographic hash of the update to the layer;
determining whether the cryptographic hash of the update to the layer exists in the backup system at a storage path; and
performing deduplication to indicate the storage path in a transaction record for the update to the layer.

8. The computer implemented method of claim 1, further comprising:
receiving an update to a layer;
determining a storage path in the backup system storing the update to the layer; and
calculating a cryptographic hash of content in the update to the layer, a parent hash in a parent transaction record in the hierarchical relationship for a previous update to the layer, and the storage path.

9. The computer implemented method of claim 1, further comprising:
receiving an update to a layer;
determining a storage path in the backup system storing the update to the layer;
encrypting the storage path; and
storing the encrypted storage path in a transaction record for the update to the layer in the hierarchical relationship.

10. The computer implemented method of claim 1, wherein the hierarchical relationship of the transaction records for the updates to the layers forms a blockchain.

11. A system comprising:
a processor set;
one or more computer readable storage media; and
program instructions stored on the one or more computer readable storage media to cause the processor set to perform operations for managing backup versions of images in a backup system comprising:
receiving updates to layers of an image;
maintaining transaction records for the updates to the layers, wherein the transaction records for the updates to the layers are represented in a hierarchical relationship;
providing a parent transaction record and a child transaction record indicated in a parent-child relationship in the hierarchical relationship, wherein the parent transaction record indicates a first update to a layer and the child transaction record indicates a second update to the layer received after the first update;
including, in the child transaction record, a cryptographic hash of input, the input comprising content in the second update to the layer and a parent hash in the parent transaction record; and
using the hierarchical relationship to manage the updates to the layers.

12. The system of claim 11, wherein the content in the second update comprises the second update and wherein the parent hash comprises a cryptographic hash of the parent transaction record and the first update.

13. The system of claim 11, wherein the input to the cryptographic hash is further selected from the group consisting of a storage path in which the second update to the layer is stored in the backup system, a user identifier of a user initiating the second update to the layer, and a timestamp of the second update.

14. The system of claim 11, wherein the operations further comprise:
receiving a request to freeze a layer at an update to the layer;
indicating the layer as frozen to prevent any further updates to the layer in the request to freeze; and
indicating a dependent layer dependent on the frozen layer to prevent any further updates to the dependent layer.

15. The system of claim 11, wherein the operations further comprise:
receiving a request to rollback a layer to a rollback update;
determining versions of updates running on other layers other than the layer to rollback;
determining whether the update versions running on the other layers are compatible with the rollback update; and
in response to determining that the update versions running on the other layers are not compatible with the rollback update, rolling back the update versions for the other layers not compatible with the rollback update to a most recent update compatible with the rollback update.

16. A computer program product comprising:
one or more computer readable storage media; and
program instructions collectively stored on the one or more computer readable storage media to perform operations for managing backup versions of images in a backup system comprising:
receiving updates to layers of an image;
maintaining transaction records for the updates to the layers, wherein the transaction records for the updates to the layers are represented in a hierarchical relationship;
providing a parent transaction record and a child transaction record indicated in a parent-child relationship in the hierarchical relationship, wherein the parent transaction record indicates a first update to a layer and the child transaction record indicates a second update to the layer received after the first update;
including, in the child transaction record, a cryptographic hash of input, the input comprising content in the second update to the layer and a parent hash in the parent transaction record; and
using the hierarchical relationship to manage the updates to the layers.

17. The computer program product of claim 16, wherein the operations further comprise:
receiving a request to freeze a layer at an update to the layer;
indicating the layer as frozen to prevent any further updates to the layer in the request to freeze; and
indicating a dependent layer dependent on the frozen layer to prevent any further updates to the dependent layer.

18. The computer program product of claim 16, wherein the operations further comprise:
receiving an update to a layer;
calculating a cryptographic hash of the update to the layer;
determining whether the cryptographic hash of the update to the layer exists in the backup system at a storage path; and
performing deduplication to indicate the storage path in a transaction record for the update to the layer.

19. The computer program product of claim 16, wherein the operations further comprise:
receiving an update to a layer;
determining a storage path in the backup system storing the update to the layer; and
calculating a cryptographic hash of content in the update to the layer, a parent hash in a parent transaction record in the hierarchical relationship for a previous update to the layer, and the storage path.

20. The computer program product of claim 16, wherein the operations further comprise:
receiving an update to a layer;
determining a storage path in the backup system storing the update to the layer;
encrypting the storage path; and
storing the encrypted storage path in a transaction record for the update to the layer in the hierarchical relationship.
